(19) United States
(12) Patent Application Publication
(10) Pub. No.: US 2011/0017349 A1
(43) Pub. Date: Jan. 27, 2011

(54) Misfuelling Prevention Assembly

(76) Inventor: Philip Cartwright, Everingham (GB)

Correspondence Address: WILLIAM D. HARE, 66 WITHERSPOON STREET, STE. 1, PMB 317, PRINCETON, NJ, 08542-9944, US

(21) Appl. No.: 12/863,720

(22) PCT Filed: Jan. 19, 2009
(86) PCT No.: PCT/GB09/00148

§ 371 Date: Oct. 4, 2010

(30) Foreign Application Priority Data
Jan. 21, 2008 (GB) 0801046.4
Jul. 15, 2008 (GB) 0812889.4

(51) Int. Cl. B60K 15/04

(52) U.S. Cl. 141/382; 141/363

(57) ABSTRACT

There is described a misfuelling prevention assembly (1) which comprises a fuel filler cap (2), said cap being provided with a releasable locking member (11) and locking member release means (6, 7) wherein the release means is actuated by the positioning of the correct fuel filler nozzle within the release means.

### FIELD OF THE INVENTION

The present invention relates to a novel assembly for the prevention of misfuelling, the use of such an assembly and a method related thereto.

### BACKGROUND TO THE INVENTION

Generally, it is possible to prevent misfuelling of a petrol driven vehicle, e.g. putting diesel into a petrol driven car, because the nozzle on a diesel pump is larger than that for a petrol car.

However, it is less easy to prevent misfuelling of a diesel engined vehicle, i.e. by putting petrol in the fuel tank. Indeed, the problem has increased with the increase in the number of diesel cars, which, in the UK, now account for one in four new cars sold.

According to the AA Trust, every year about 120,000 motorists in the UK fill the fuel tank of their car with the incorrect fuel. Other organizations, such as car hire companies, have estimated that the cost of misfuelling in the UK alone may be as high as £800 million per year.

If misfuelling of a diesel engine occurs and the vehicle is not driven away, the cost of repair may be in the region of £200 for emptying and flushing the vehicle's fuel system.

However, if a diesel engined vehicle is driven with the incorrect fuel in the tank the cost can be from £3,000 to £4,000 or more. This leads some car hire companies to adopt the position that if misfuelling occurs in, for example, a small car, the car may be scrapped rather than repaired. The problem is that, inter alia, with increasingly stringent exhaust emission regulations, the fuel and catalyst systems in cars can be damaged by only a small amount of the incorrect fuel being present. Furthermore, with modern diesel engines which use extremely high fuel injection pressures, the viscosity of the fuel is critical. The reason is that production tolerances are now microscopic and petrol allows catastrophic metal-to-metal contact. Any petrol present can cause scarring of the pump elements and the seals can be damaged by compounds found in the petrol Due to the fine tolerances of today's fuel systems the wrong fuel can lead to major fuel pump and high-pressure injection-system damage. This damage may not be covered by insurance because many policies exclude misfuelling.

It will also be appreciated that the present invention is not restricted to petrol-diesel misfuelling prevention for automotive engines, but can be adapted for use with any engines and any fuels where there is a risk of misfuelling, such as aviation jet fuel/gasoline misfuelling of aeroplane engines.

There have been numerous attempts to address this problem. Thus, for example, Ford have recently introduced their EASY FUEL™ device which comprises a sealed filler pipe insert and fuel nozzle locator that guides the nozzle to the tank opening. The insert contains a mechanically operated diameter detector which only allows the larger diesel fuel nozzle to be inserted into the filler pipe, and locks out the smaller diameter petrol/gasoline nozzles. This device is sold fitted to newly manufactured vehicles. However, the Ford EASY FUEL device is not suitable for retrofitting to the vast number of diesel driven vehicles already in use in the UK and elsewhere.

We have now found a novel misfuelling prevention assembly which overcomes or mitigates the disadvantages of known prior art systems and may be retro fitted to existing motor vehicles.

### STATEMENTS OF THE INVENTION

Essentially, the invention comprises lockable fuel filler cap which may only be released by actuation of the unlocking mechanism with the desired fuel filler nozzle. Importantly, locking mechanism may only be released by the use of the correct fuel filler nozzle.

Thus, according to the invention we provide a misfuelling prevention assembly which comprises a fuel filler cap, said cap being provided with a releasable locking member and locking member release means wherein the release means is actuated by the positioning of the correct fuel filler nozzle within the release means.

More particularly, the releasable locking member is adapted to engage with the neck of a vehicle's fuel filler neck, i.e. the neck of the pipe that leads to the fuel tank, or alternatively with an adapter as described herein located within the neck of the pipe. Furthermore, the releasable locking member may comprise a base member and a substantially circumferential claw which is radially biased inwardly to a locking position. Thus, the claw may comprise a member the gripping portion of which is essentially L-shaped in cross-section, such that the lip of the L-shaped locking member is adapted to engage with the rim of the filler neck in a lockable fashion, or alternatively, with an adapter as described herein located within the filler neck.

Preferably, the base member is provided with an orifice, said orifice being fitted with a circumferential release ring. The releasable ring is generally spring loaded and inwardly radially biased, i.e. towards the centre point. The release ring is adapted to be expanded outwards radially when the correct fuel filler nozzle is introduced into the release ring. Importantly, the release ring will not expand if the incorrect nozzle is used. Thus, in order to facilitate the expansion of the release ring as hereinbefore described, the release ring may comprise a plurality of sections. The preferred number of section is three, although it will be understood that any number of sections or segments may be utilised. The release ring is dimensioned, such that, for example a smaller petrol/gasoline filler nozzle will form a snug fit within the internal dimensions of the release ring, but would not expand the ring and consequently the claw is not released. On the other hand, a larger diesel filler nozzle when inserted into the release ring would urge the ring to expand, causing the claw to be released. Conventionally a diesel filler nozzle will comprise a 25 mm diameter pipe, whilst a petrol/gasoline nozzle will comprise a 19 mm diameter pipe. Therefore, in its dormant or locked position the ring will generally comprise a 19 mm diameter aperture, but will be capable of expanding, e.g. 6 mm, to a 25 mm aperture. If a 19 mm petrol nozzle is inserted, for example, on a 90 degree lateral plane, its diameter would not touch the contact section on the release section and would not move away from the centre.

Although the release ring or the segments of the release ring may comprise a variety of different designs, preferably each of the segment(s) may comprise a moulded plastics unit, such that the unit is provided with at least one guide peg which may be located within a longitudinal slot; and at least one or more, preferably two, biasing members. The one or more biasing members may comprise conventional spring biasing members. However, preferably the one or more biasing members may comprise a pin in a fixed position associated with a resiliently deformable plastics sheath, such that the plastics sheath is integral to the release ring or the segment of the release ring.

In one embodiment of the invention the cap includes a base member, which may preferably be provided with a substantially central sleeve or conduit, which is adapted to fit within the filler neck of a vehicle, or, optionally, the filler neck adapter. Furthermore, the base member may be provided with a seal, e.g. in the form of an O-ring around or adjacent to the sleeve. In an alternative embodiment of the invention the central sleeve or conduit is replaced by a T-member, which member is provided with a sealing plug which is optionally held in position by a spring.

The base plate may be connected to the cap using conventional means. However, preferably, the connection comprises a snap fit. Thus, for example, one or more connection members may protrude through the releasable locking member enabling the base member and the cap to engage with one another.

It will be appreciated by a person skilled in the art that the releasable fuel filler cap may be adapted to operate in conjunction with a conventional filler neck. However, in a preferred aspect of the invention the misfuelling prevention assembly of the invention includes a filler neck adapter. Advantageously, such a filler neck adapter will comprise, inter alia, a substantially circumferential lip which is adapted to engage with the jaw of the locking member of the assembly.

In a yet further aspect of the invention we provide a method of preventing misfuelling of a vehicle which comprises the use of an assembly as hereinbefore described.

In an additional aspect of the invention we provide a kit comprising a releasable fuel filler cap as hereinbefore described and a fuel filler neck adaptor, each as hereinbefore described.

The kit and/or the assembly according to the invention is especially advantageous in that it may be retro fitted to existing vehicles.

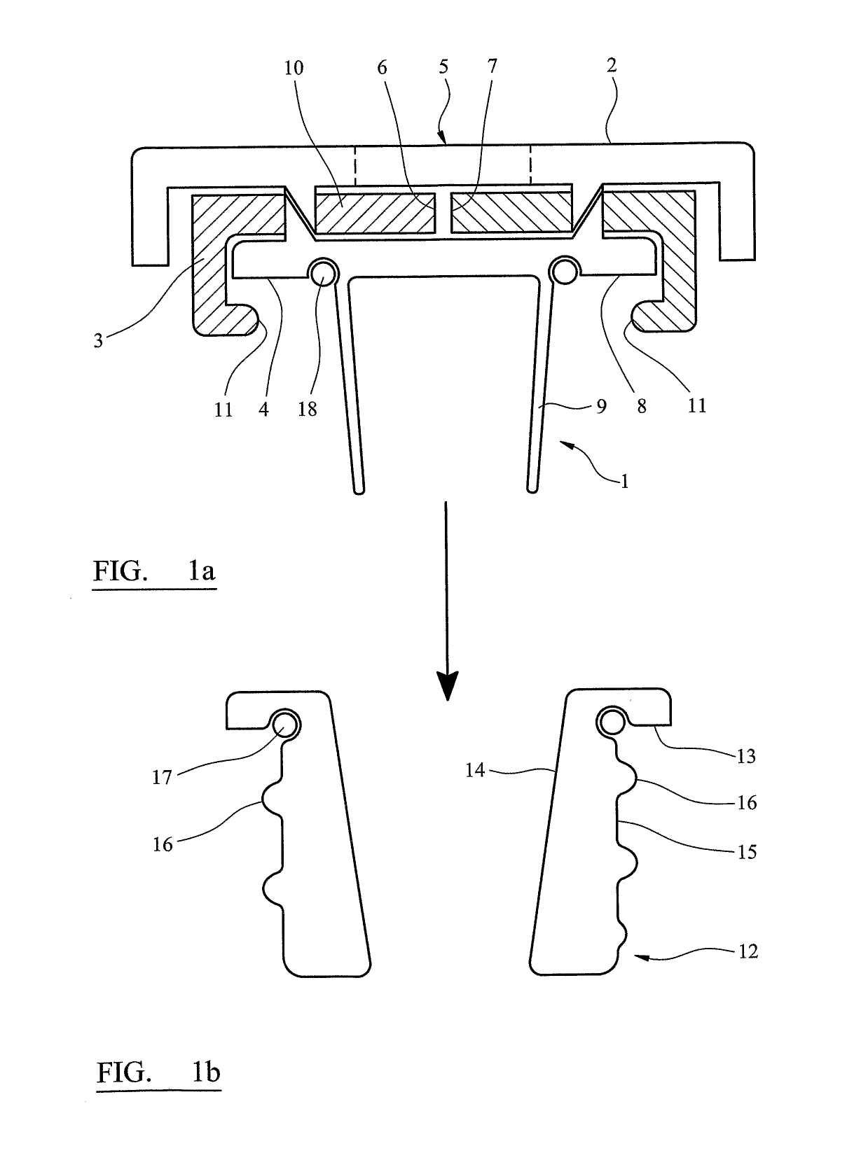

The invention will now be described by way of example only and with reference to the accompanying drawings in which FIG. 1a is a cross-sectional representation of a misfuelling prevention cap according to the invention;

FIG. 1b is a cross-sectional representation of a filler neck assembly;

FIG. 2 is a schematic representation of a release ring of the invention;

FIG. 3 is a schematic representation of a segment of a release ring of FIG. 2;

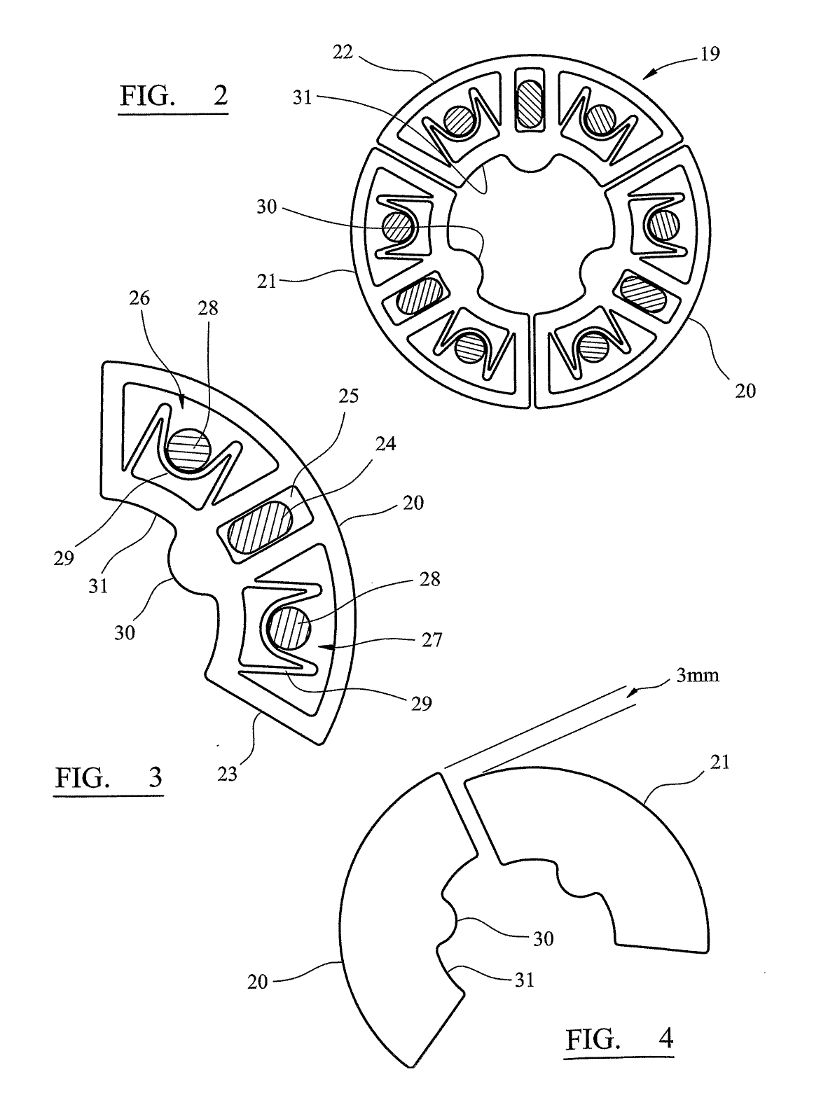

FIG. 4 is a schematic representation of a segment of a release ring being expanded by, for example, a petrol filler nozzle;

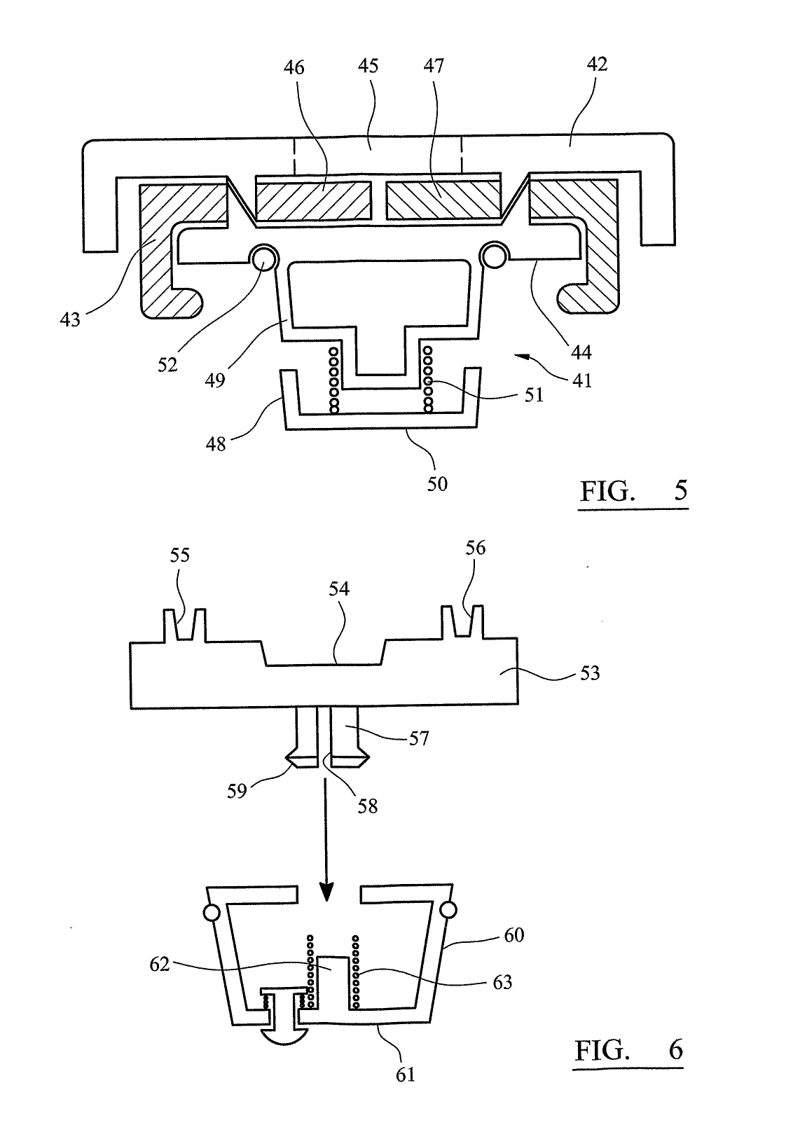

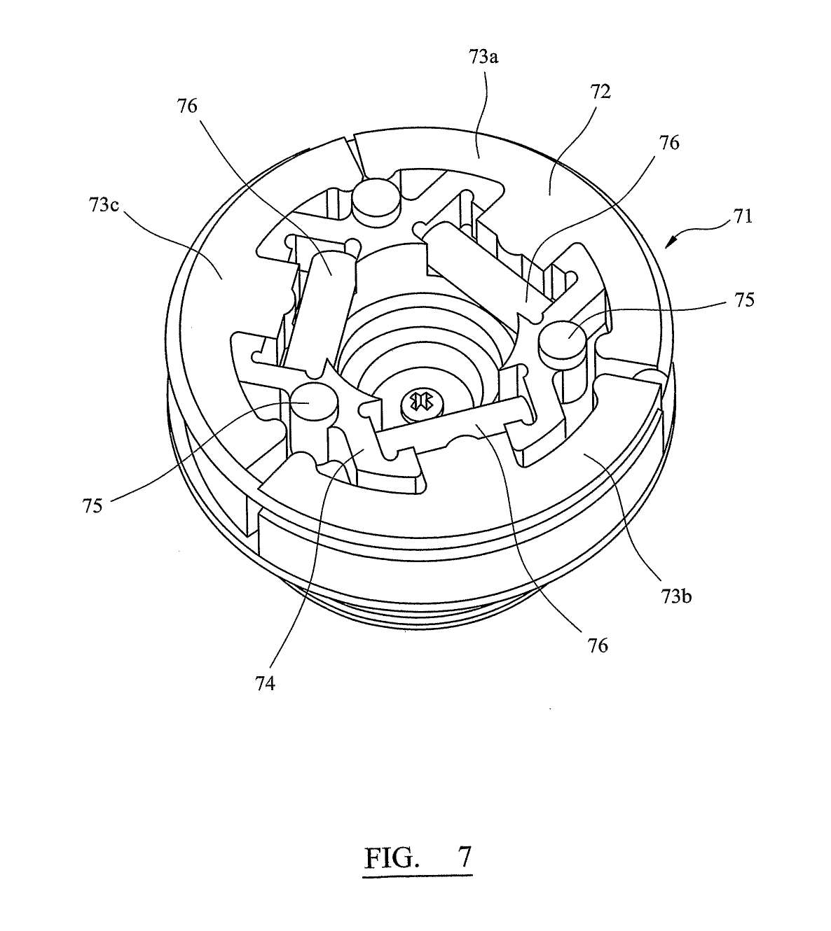

FIG. 5 is a cross-sectional representation of a misfuelling prevention cap according to the invention provided with a sealing plug;

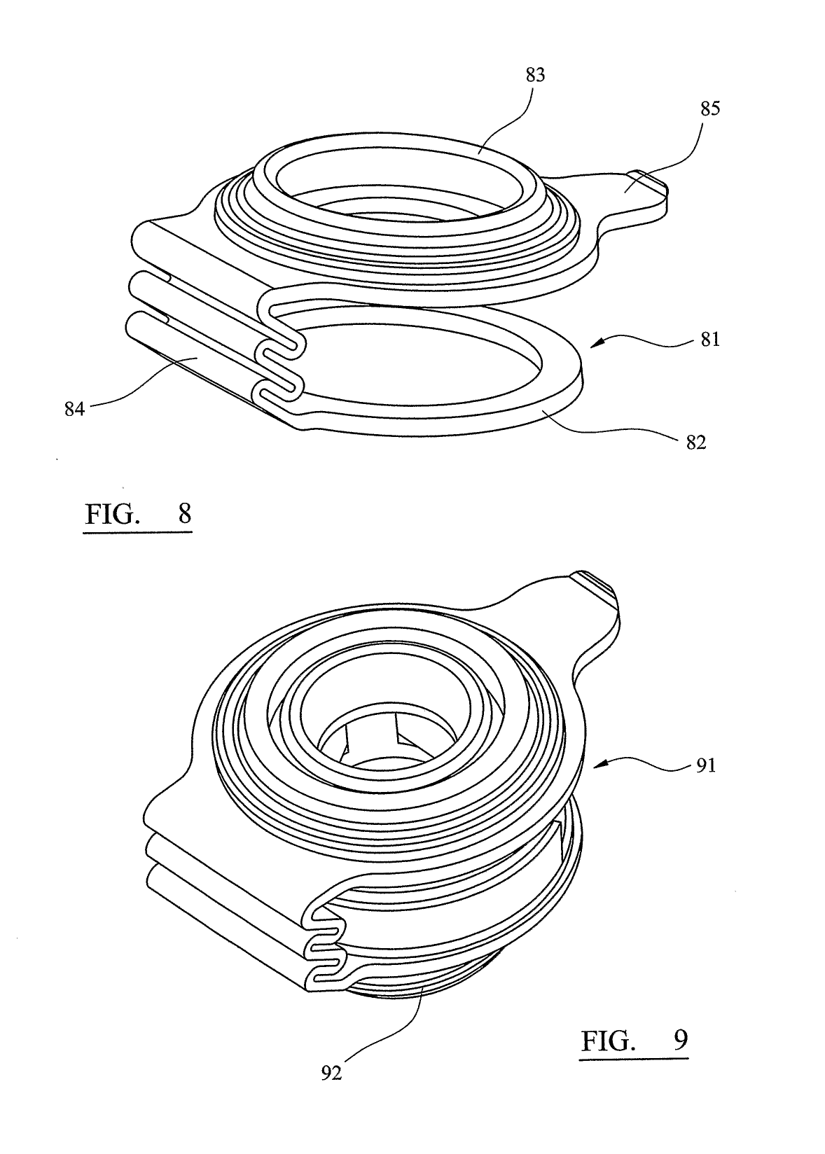

FIG. 6 is a cross-sectional representation of a sealing plug connection;

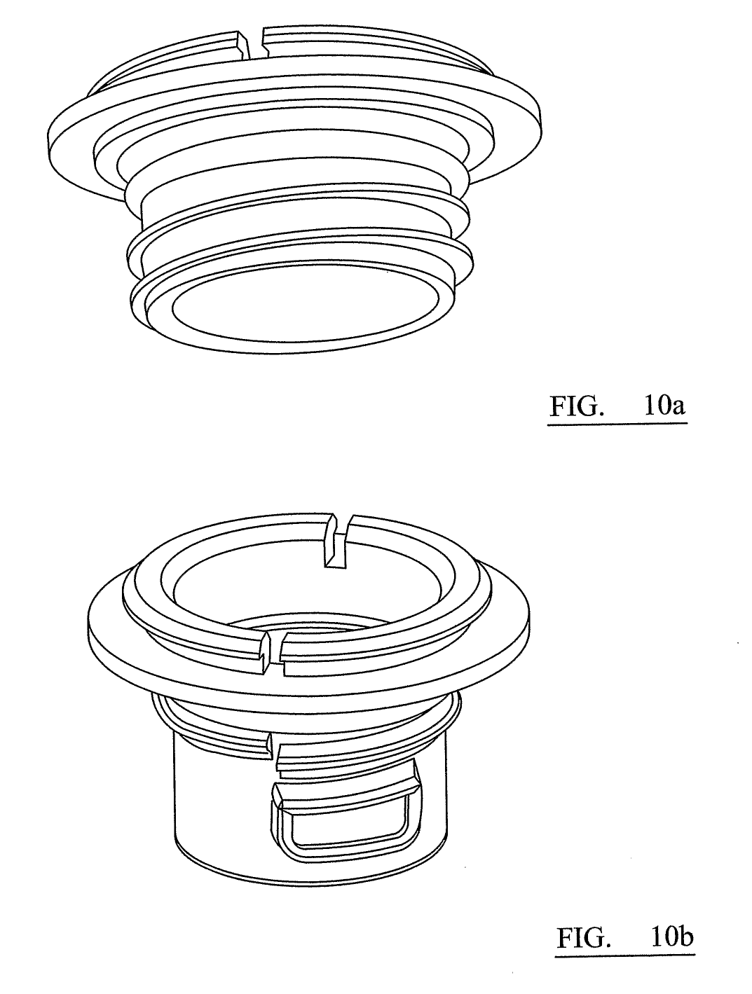

FIG. 7 is an alternative embodiment of the filler neck assembly provided with rollers;

FIG. 8 is a perspective view of a lanyard for use with the assembly;

FIG. 9 is a perspective view of a lanyard in situ on the assembly;

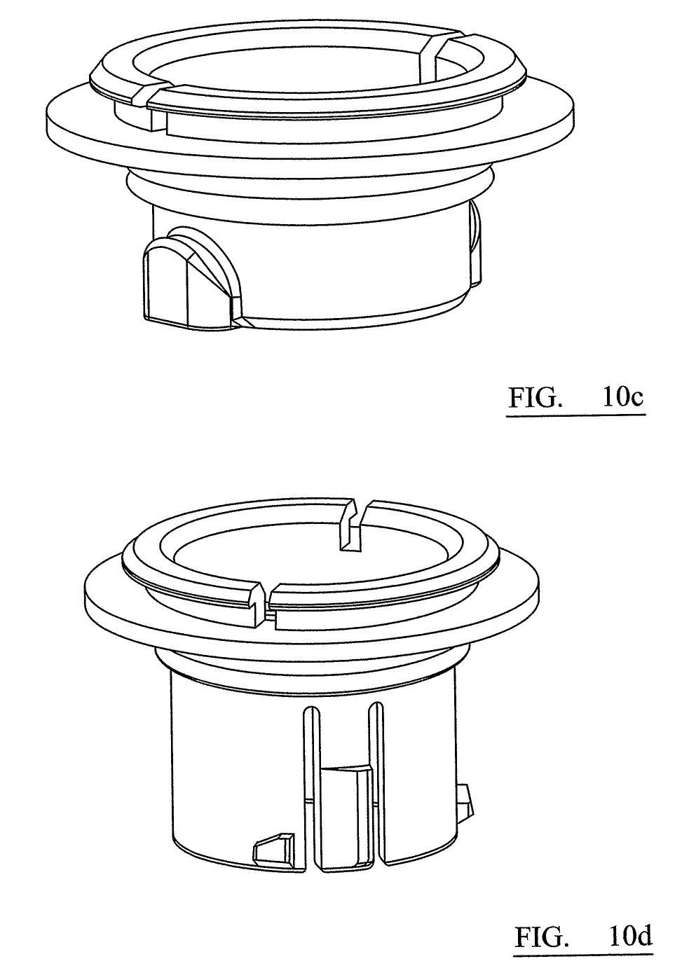

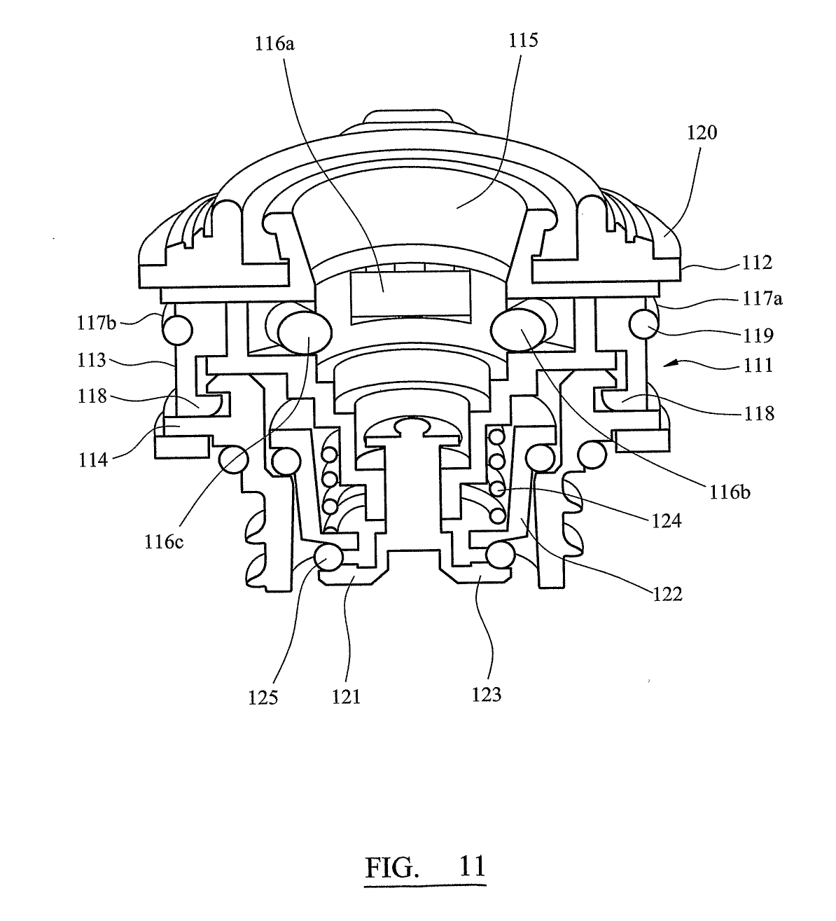

FIGS. 10 a to d are adapter to be used in conjunction with the assembly; and

FIG. 11 is a cross-section of the complete assembly.

Referring to FIGS. 1a and 1b, a misfuel prevention assembly 1 comprises an outer cap 2, e.g. with a maximum size 65 mm diameter, and an inner cover 3 and a base plate 4. The outer cap 2 having an aperture 5 through it, to allow a (25 mm) diesel fuel nozzle (not shown) to pass through and to connect with the release sections, two for which are shown 6 and 7, the release sections 6 and 7 extend radially and the inner cover 3 comprises a circumferential claw 11, which is substantially L-shaped in cross section.

The base plate 4 is provided with a circumferential peripheral rim 8 and a central conduit 9. The inner cover 3 is provided with a releasable locking member 10.

In the embodiment shown in FIG. 1b, the assembly 1 also comprises an adaptor collar 12 which comprises a peripheral circumferential lip 13 and an internal neck 14 which is substantially inverted frusto conical in shape. The external wall 15 is provided with raised regions 16 adapted to engage with the inner surface of the fuel filler neck of the vehicle (not shown). The adaptor collar 12 is optionally provided with an O-ring seal 17 adapted to form a seal with the rim of the fuel filler neck of the vehicle (not shown). Conduit 9 may also be provided with an O-ring seal 18 about it. In use, when a diesel fuel nozzle is inserted through the aperture 5 the release sections 6 and 7 (plus others not shown) of the locking member 10 are pushed apart each by 3 mm to the recreate an aperture with the correct diameter of 25 mm required for a diesel nozzle. Consequently, the circumferential claw 11 is released enabling the assembly 1 to be removed from the neck of the fuel filler pipe or adaptor collar 12. The fuel filler nozzle may be removed from the locking member and be used to fill the fuel tank of the vehicle. When the filling of the tank is complete, the assembly 1 is pushed back onto the filler neck or the adaptor collar 12, the edge of the radial claw 11 is spread by the reciprocal edge of the neck or collar as they have a matched taper, as the claw 11 passes the high point of the lip 13 on the collar 12 it returns to its inwardly biased point and grips the collar 12 or filler neck and a seal is formed by the sealing plug hereinbefore described.

Referring to FIGS. 2 and 3 a locking ring 19 comprises three segments 20, 21 and 22. Within the arrangement of three locking segments 20, 21 and 22 each segment comprises a moulded plastics unit 23, such that the unit 23 is provided with a guide peg 24 located within a longitudinal slot 25; and a pair of biasing members 26 and 27. Each biasing member 26 and 27 comprises a fixed pin 28 located in a resiliently deformable plastics sheath 29, such that the plastics sheath 29 is integral to the segment of the release ring. A contact region 30 is provided on the surface 31 of the segment 20 that cooperates with aperture 5.

Referring to FIG. 4, if a 19 mm petrol nozzle (not shown) is inserted on a 90 deg lateral plane its diameter would not touch all of the contact region 30 on the release section would not move away from the centre. In FIG. 4, two of the three release sections (20, 21 and 22 are schematically shown (21 in its locked position and 20 in its unlocked position), the contact sections are arranged in a circle of 19 mm. In use, if a 19 mm nozzle it inserted none of (or only one of) the segments 20 are moved back any distance. In the example shown segments 20 is being pushed back from its resting position at it fullest extension it will have moved 3 mm. Segment 21 is not being pressed because the object being inserted (say a 19 mm petrol nozzle) can only touch one contact region 30 at a time.

Thus, it is clear that in order for the mechanism to be released all (three) of the release regions 30 would need to be pushed back to their fullest extent at the same time. However, it will be understood that if a 25 mm diesel nozzle was inserted it would make equal contact on each contact surface, and as the nozzle was pushed home all three release regions 30 would move away the required distance from the centre to release the locking mechanism.

Similarly, an object with too large a diameter would not be allowed to contact the release region contact point because of the calibrated aperture 5 in the cap 2. For example a 25 mm diesel nozzle would to fit into a unit designated for a 19 mm petrol nozzle.

Referring to FIG. 5 an alternative design of a misfuel prevention assembly 41 comprises an outer cap 42, an inner cover 43 and a base plate 44. The outer cap 42 having an aperture 45 through it, to allow a diesel fuel nozzle (not shown) to pass through and to connect with the release sections 46 and 47 of the inner cover 43. For the avoidance of doubt, release sections 6 and 7, locking member 10, and radial claw 11 are all areas of the same part as shown in plan view in FIG. 3, and as a group of three in FIG. 2.

The base plate 44 is provided with a sealing plug 48 which is located on a tower 49 which extends from the lower portion of the base plate 44. The plug 49 comprises a releasable base portion 50 which is held to the body of the plug 49 by a biasing member 51, i.e. a coiled spring,

In use, the assembled unit in a locked position, the sealing plug 49 is pressed against the adaptor collar (not shown) by the spring 51 and a seal is formed by the circumferential O-ring 52, In the event of the filler neck air pressure being increased to a dangerous level (say by ambient conditions) this pressure may be released because the pressure acting on the inner side of the base portion 50 would become greater than the spring pressure created by the spring 51.

In such a case the excess pressure would temporarily break the seal created by O-ring 52 and the pressure would be vented to atmosphere. As the filler neck pressure drops, so the pressure of the spring 51 would become greater and the seal would be re-established.

When the unit is unlocked, this spring 51 also assists in the separation of the assembled unit from the adaptor collar (not shown).

Referring to FIG. 6 a base plate 53 is provided with a blind hole 54 with a diameter greater than 19 mm but less than 25 mm. When too small an object, such as a fuel filler nozzle (not shown) is inserted into the base plate 53 the object becomes trapped by the hole 54, i.e. it can not move sideways onto the contact points of the release sections (not shown).

The base plate 53 is also provided with a pair of pegs 55 & 56 (although it will be understood by a person skilled in the art that any number of pegs may be used) which protrude from the base plate 53. The pegs 55 & 56 are essentially hollow to allow reciprocal pegs on the outer cap (not shown) to be engagably located inside them and enabling the cap to be secured to the base plate. The cover 3 and the base plate 53 form a sandwich which retains the locking sections. One arrangement is shown in FIG. 2, there is a sufficient gap between all of the components to allow the moving sections to slide without binding. Protruding away form the outer cap, the base plate 53 is also provided with a hollow split pin 57. Thus the pin 57 is provided with one or more i.e. four longitudinal slits 58 in its end 59.

A sealing plug 60 is provided in its base 61 with a corresponding locating pin 62, such that the split pin 57 and the locating pin 62 engage in a male/female fashion, i.e. the locating pin 62 is inserted inside the hollow split pin 57. The split pin 57 will generally comprise a resilient plastics material and thus the sealing plug 60 will be held in place. The locating pin 62 is also positioned inside a biasing member 63, i.e. a coiled spring.

The use of the assembly of FIG. 6 is analogous to that of referred to in respect of FIG. 5 herein.

Generally, the blind hole 54 is 19.5 mm wide to trap a 19 mm (diesel) nozzle and restrict its sideways movement. Its depth is limited to the thickness of the base plate 53 which must be kept to a minimum. The depth of the cap (not shown) is matched to the depth of the plug 60. Typically, the plug 60 will be 20 mm deep and its diameter matched to the inner diameter of the adaptor collar (not shown) typically 30 mm and tapering.

The diameter and cross section of the plug 60 should be substantially matched to the inner surface profile of the adaptor collar (not shown).

The assembly is also advantageous in that the nature of diesel fuel is such that the moving components are lubricated by the small amount of residual fuel present on the outer side of the fuel nozzle when it is introduced into the assembly.

Furthermore, the outer cover 2 may have a raised turret around aperture 5 which may be gripped by hand to allow the re-fitting of the assembly after fuelling. This turret may optionally be provided with a circumferential groove around its outer edge in which an elastic lanyard may optionally be located, such that the lanyard may be attached to the car body so that in use the assembly is not lost.

Referring to FIG. 7, an alternative embodiment of misfuel prevention assembly 71 comprises a locking ring 72 which comprises three segments 73a, 73b and 73c. Within the arrangement of three locking segments 73a, 73b and 73c each segment is provided with a moulded plastics unit 74, which it shares with an adjacent segment, enabling adjacent segments 73a, 73b and 73c to cooperate with each other. Each unit 74 is also provided with a guide peg 75 located within the unit 74. Each segment is also provided with a roller 76 which, in use, acts as a contact region for the fuel nozzle (not shown).

Referring to FIG. 8, a lanyard 81 comprises a fuel pipe engaging ring 82, a fuel cap engaging ring 83, a flexible connector 84 joining the rings 82 and 83, and a release tab 85.

Referring to FIG. 9 a lanyard 91 is located on a misfuel prevention assembly 92.

Referring to FIGS. 10 a to d, a range of adapters may be used in conjunction with the assembly (not shown) enabling the assembly to fit a large variety of commercially available vehicles.

Referring to FIG. 11 misfuel prevention assembly 111 comprises an outer cover 112 and an inner cap 113 and a base plate 114. The outer cover 112 having an aperture 115 through it, to allow a (25 mm) diesel fuel nozzle (not shown) to pass through and to connect with the rollers 116a, b, and c. The releasable locking segments 117a and b are provided with a circumferential claw 118 and are held in the closed position by an O-ring 119.

The detachable outer cover 112 is also retained in close association with the assembly 111 by a lanyard 120. The base plate 114 is provided with a sealing plug 121 which is located on a tower 122 which extends from the lower portion of the base plate 114. The plug 121 comprises a releasable base portion 123 which is held to the body of the plug 121 by a biasing member 124, i.e. a coiled spring, A sealing member 125, in the form of an O-ring is provided between the releasable base portion 123 and the body of the plug 121.

1. A misfuelling prevention assembly which comprises a fuel filler cap, said cap being provided with a releasable locking member and locking member release means wherein the release means is actuated by the positioning of the correct fuel filler nozzle within the release means.

2. A misfuelling prevention assembly according to claim 1 wherein the locking member comprises a base member and a substantially circumferential claw which is radially biased inwardly to a locking position.

3. A misfuelling prevention assembly according to claim 2 wherein the claw comprises a member which is essentially L-shaped in cross-section.

4. A misfuelling prevention assembly according to claim 3 wherein the lip of the L-shaped locking member is adapted to engage with the rim of the filler neck in a lockable fashion.

5. A misfuelling prevention assembly according to claim 1 wherein the locking member is provided with an orifice, said orifice being fitted with a circumferential release ring.

6. A misfuelling prevention assembly according to claim 5 wherein the release ring is generally spring loaded and inwardly radially biased and is adapted to be expanded outwards radially when a fuel filler nozzle is introduced into the release ring.

7. A misfuelling prevention assembly according to claim 5 wherein the release ring comprises a plurality of sections.

8. A misfuelling prevention assembly according to claim 7 wherein the release ring comprises three sections.

9. A misfuelling prevention assembly according to claim 5 wherein the release ring is dimensioned such that the release ring will be actuated by a diesel filler nozzle.

10. A misfuelling prevention assembly according to claim 9 wherein the release ring defines a 19 mm diameter ring that is capable of expanding 6 mm.

11. A misfuelling prevention assembly according to claim 1 wherein the cap includes a base member provided with a substantially central sleeve, which is adapted to fit within the filler neck of a vehicle.

12. A misfuelling prevention assembly according to claim 11 wherein the cap includes a base member in the form of a T-member, which member is provided with a sealing plug which is optionally held in position by a spring.

13. A misfuelling prevention assembly according to claim 1 wherein the assembly is adapted to operate in conjunction with a filler neck adapter.

14. A misfuelling prevention assembly according to claim 2 wherein the filler neck adapter comprises a substantially circumferential lip adapted to engage with the claw of the locking assembly.

15. A method of preventing misfuelling of a vehicle which comprises the use of a misfuelling prevention assembly which comprises a releasable fuel filler cap, said cap being provided with a neck locking member and locking member release means wherein the release means is actuated by the positioning of the correct fuel filler nozzle within the release means.

16. A kit comprising a releasable fuel filler assembly cap which comprises a releasable fuel filler cap, said cap being provided with a neck locking member and locking member release means wherein the release means is actuated by the positioning of the correct fuel filler nozzle within the release means; and a fuel filler neck adapter.

17. A kit according to claim 16 which comprises a plurality of fuel filler neck adapters.

18. A misfuelling prevention assembly according to claim 1, further comprising a fuel filler neck adapter kit for use with the misfuelling prevention assembly.

19. A kit according to claim 16, further comprising a fuel filler neck adapter kit for use with the kit.

20. A misfuelling prevention assembly according to claim 1, further comprising a lanyard for use in conjunction with the misfuelling prevention assembly, the lanyard comprising a fuel pipe engaging ring, a fuel cap engaging ring, a flexible connector joining the rings, and a release tab.

21. (canceled)
